(19) United States
(12) Patent Application Publication
(10) Pub. No.: US 2015/0051758 A1
(43) Pub. Date: Feb. 19, 2015

(54) Method and System for Landing of Unmanned Aerial Vehicle

(71) Applicant: KOREA AEROSPACE RESEARCH INSTITUTE, Daejeon (KR)

(72) Inventor: Am CHO, Daejeon (KR)

(73) Assignee: KOREA AEROSPACE RESEARCH INSTITUTE, Daejeon (KR)

(21) Appl. No.: 14/099,391

(22) Filed: Dec. 6, 2013

(30) Foreign Application Priority Data
Aug. 16, 2013 (KR) 10-2013-0097007

(51) Int. Cl. G08G 5/02

(52) U.S. Cl. CPC G08G 5/02
USPC 701/16

(57) ABSTRACT

A method and a system for landing an Unmanned Aerial Vehicle (UAV) are provided. The method for landing the UAV includes recognizing a mark installed to the UAV through a plurality of vision sensors installed around a landing point of the UAV, and calculating a relative location of the UAV based on the landing point using the mark recognized by the vision sensors. Hence, the plurality of the sensors installed near the landing point can calculate more precise location and position of the UAV using the relative location of the UAV and the absolute location of the landing point by recognizing the mark attached to the UAV, and thus the UAV can land on the landing point accurately.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on, and assigned Serial No. 10-2013-0097007 filed in the Korean Intellectual Property Office on Aug. 16, 2013, the entire disclosure of which is hereby incorporated by reference.

### TECHNICAL FIELD OF THE INVENTION

The present invention relates generally to a method and a system for landing an unmanned aerial vehicle. More particularly, the present invention relates to a method and a system for lading an unmanned aerial vehicle on a landing point in a manner that a plurality of sensors installed around the landing point recognizes a mark attached to the unmanned aerial vehicle.

### BACKGROUND OF THE INVENTION

In general, an Unmanned Aerial Vehicle (UAV) is an aircraft which flies without a human pilot according to a preset program or autonomously by recognizing its surrounding environment (an obstacle or a path) in order to fulfill a designated mission. Recently, the UAV is used for various purposes such as weather observation, topographical survey, reconnaissance, or surveillance.

To land the UAV, the related art applies a landing method controlled by an external pilot, an automatic landing method using navigation equipment, or an automatic landing method using radar.

However, the landing method controlled by the external pilot lands the UAV based on visual observation of the external pilot or comparison of a map and the flight path with the naked eyes of an internal control center. The landing of the UAV depends on the visual observation of the pilot. Accordingly, when an obstacle exists around a runway, the UAV flies at night, or the weather is not good, the pilot is burdened.

The automatic landing method using the navigation equipment lands the UAV on the landing point using autopilot such as a Global Positioning System (GPS) or an Inertial Navigation System (INS). Since the UAV can malfunction because of radio disturbance, the landing of the UAV is subject to a serious risk.

The automatic landing method using the radar lands the UAV on the landing point by emitting radio signals of the radar to the UAV, calculating a propagation time, calculating a distance to the runway, and processing the distance to the runway and an altitude of the UAV. Since a high-priced landing device is required on the ground to emit the radio signals of the radar and the propagation of the radar is easily exposed to the disturbance of jamming, it is difficult to accurately measure the distance to the runway.

### SUMMARY OF THE INVENTION

To address the above-discussed deficiencies of the prior art, it is a primary aspect of the present invention to provide a method and a system for landing an unmanned aerial vehicle accurately on a landing point by calculating more precise location and position of the unmanned aerial vehicle using a relative location of the unmanned aerial vehicle which is obtained by a plurality of sensors installed around the landing point by recognizing a mark attached to the unmanned aerial vehicle, and an absolute location of the landing point.

According to one aspect of the present invention, a method for landing an Unmanned Aerial Vehicle (UAV) includes recognizing a mark installed to the UAV through a plurality of vision sensors installed around a landing point of the UAV; and calculating a relative location of the UAV based on the landing point using the mark recognized by the vision sensors.

The method may further include sending the relative location of the UAV and an absolute location of the landing point to the UAV.

The method may further include calculating a vision sensor based absolute location of the UAV using the relative location of the UAV and an absolute location of the landing point.

The method may further include correcting a location error of the absolute location of the UAV calculated by an Inertial Navigation System (INS) of the UAV using a Global Positioning System (GPS) location measured by a GPS receiver of the UAV and the vision sensor based absolute location.

According to another aspect of the present invention, a computer-readable medium records a program for executing one of the methods in a computer.

The correcting of the location error of the absolute location of the UAV calculated by the INS of the UAV may include calculating an absolute location of the UAV calculated by the INS of the UAV; calculating a first differential value corresponding to a difference between the absolute location of the UAV calculated by the INS and the GPS location measured by the GPS receiver of the UAV; calculating a second differential value corresponding to a difference between the absolute location of the UAV calculated by the INS and the vision sensor based absolute location; calculating the location error of the absolute location of the UAV measured by the INS by Kalman-filtering the first differential value and the second differential value; and correcting the location error at the INS based absolute location and obtaining the corrected absolute location of the UAV.

A system for landing an UAV includes a plurality of vision sensors installed around a landing point of the UAV and recognizing a mark installed to the UAV; and a ground device for calculating a relative location of the UAV based on the landing point using the mark recognized by the vision sensors.

The ground device may send the relative location of the UAV and an absolute location of the landing point to the UAV.

The UAV may calculate a vision sensor based absolute location of the UAV using the relative location of the UAV and an absolute location of the landing point.

The UVA may correct a location error of the absolute location of the UAV calculated by an INS of the UAV using a GPS location measured by a GPS receiver of the UAV and the vision sensor based absolute location.

The UAV may correct the location error of the absolute location of the UAV calculated by the INS of the UAV, calculate an absolute location of the UAV calculated by the INS of the UAV, calculate a first differential value corresponding to a difference between the absolute location of the UAV calculated by the INS and the GPS location measured by the GPS receiver of the UAV, calculate a second differential value corresponding to a difference between the absolute location of the UAV calculated by the INS and the vision sensor based absolute location, calculate the location error of the absolute location of the UAV measured by the INS by Kalman-filtering the first differential value and the second differential value, correct the location error at the INS based absolute location, and obtain the corrected absolute location of the UAV.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram of an Unmanned Aerial Vehicle (UAV) landing system according to an exemplary embodiment of the present invention;

FIG. 2 is a flowchart of operations of the UAV landing system according to an exemplary embodiment of the present invention;

FIG. 3 is a flowchart of operations of the UAV landing system according to another exemplary embodiment of the present invention;

FIG. 4 is a diagram of an algorithm for calculating a corrected location of the UAV by estimating an error of a conventional INS; and

FIG. 5 is a diagram of an algorithm for calculating the corrected location of the UAV by estimating an error of an INS according to an exemplary embodiment of the present invention.

Throughout the drawings, like reference numerals will be understood to refer to like parts, components and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

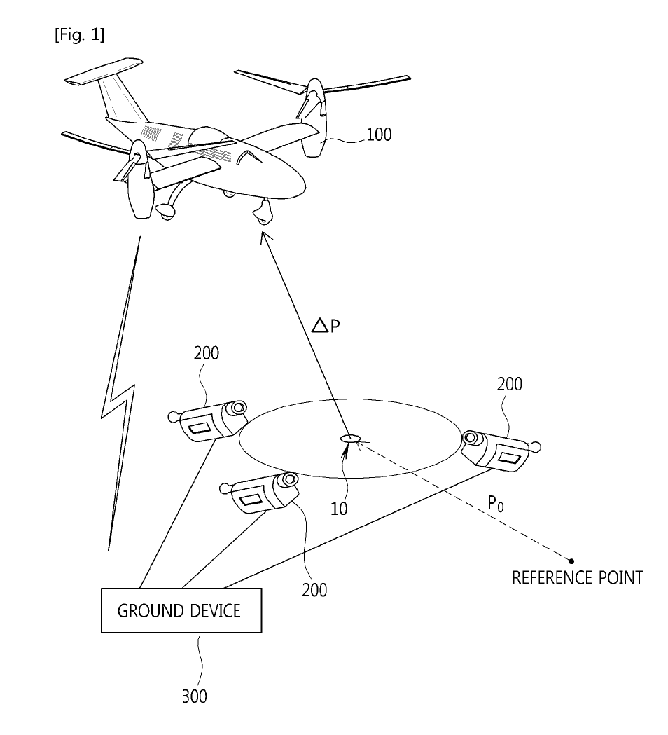

FIG. 1 depicts an Unmanned Aerial Vehicle (UAV) landing system according to an exemplary embodiment of the present invention.

Referring to FIG. 1, the UAV landing system can include a UAV 100, a plurality of vision sensors 200, and a ground device 300.

The UAV 100 can land on a landing point 10 using its relative location AP received from the ground device 300 and an absolute location P₀ of the landing point 10. In particular, the UAV 100 can include a mark (not shown), so that the vision sensors 200 can locate the UAV 100. The mark may emit visible light, infrared light, or light or heat of a particular wavelength or be formed in a particular shape or color

Since the vision sensor 200 on the ground of the landing point 100 captures the UAV 100 in the sky, it is preferred that the mark is disposed at the bottom of the UAV 100.

The vision sensor 200 can be implemented using a CCD camera or an infrared camera and send an image of the mark of the UAV 100 to the ground device 300.

It is well known in the art that coordinates of an object included in two images captured by two cameras disposed at preset locations and positions based on a reference point are calculated. Hence, the present UAV landing system can also include at least two vision sensors 200 at preset locations around the landing point 10. To enhance accuracy, the number of the visions sensors 200 may be increased.

The ground device 300 can calculate the relative location ΔP of the UAV 100 based on the landing point 10 using the image captured by the vision sensor 200. The ground device 300 can wirelessly transmit the relative location ΔP to the UAV 100 together with the known absolute location P₀ of the landing point 10. Notably, an absolute location VISION of the UAV 100 may be calculated and transmitted by combining the absolute location P₀ of the landing point 10 and the relative location ΔP. Hereafter, the absolute location P_{VISION} of the UAV 100 calculated by combining the absolute location P₀ of the landing point 10 and the relative location ΔP is referred to as a vision sensor based absolute location.

The UAV 100 can land on the landing point 10 using the absolute location P₀ of the landing point 10 and the relative location ΔP of the UAV 100 received from the ground device 300, or using the vision sensor based absolute location P_{VISION} received from the ground device 300.

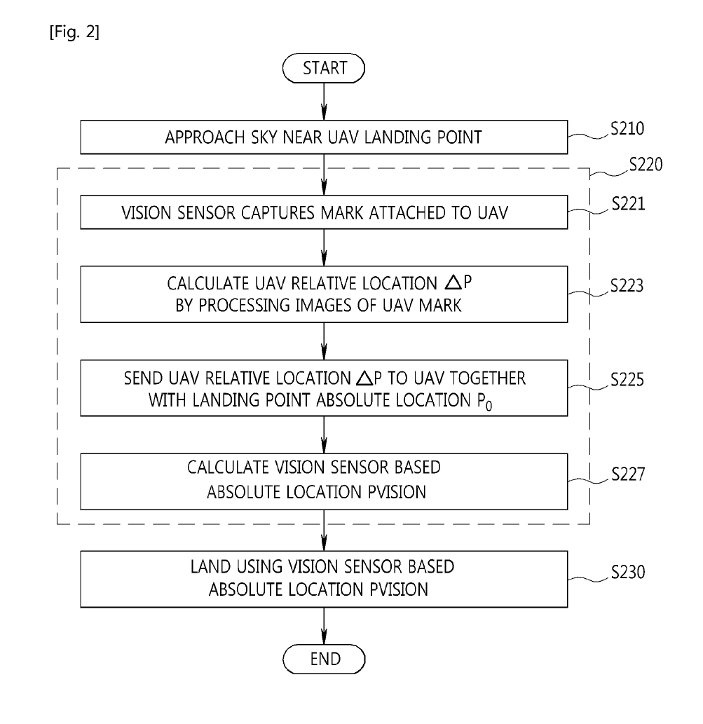

FIG. 2 is a flowchart of operations of the UAV landing system according to an exemplary embodiment of the present invention.

Referring to FIGS. 1 and 2, the UAV 100 can approach the sky close to the landing point 10 using its camera (not shown), a GPS receiver (not shown), and/or an Inertial Navigation System (INS) (not shown) in S210. For example, the UAV 100 can locate and approach the landing point 10 using its camera. Alternatively, the UAV 100 may use GPS information obtained through the GPS receiver installed. When the UAV 100 approaches the landing point 10 using its camera in S210, a specific mark needs to be installed in the landing point 10.

In S220, the UAV 100, when entering a certain range of the landing point 10, performs precision landing.

First, the vision sensors 200 send the image of the mark of the UAV 100 to the ground device 300 in S221. In S223, the ground device 300 calculates the relative location ΔP of the UAV 100 by processing the images.

In S225, the ground device 300 wirelessly transmits the relative location ΔP to the UAV 100 together with the absolute location P₀ of the landing point 10. In S227, the UAV 100 can calculate its vision sensor based absolute location P_{VISION} using the absolute location P₀ of the landing point 10 and the relative location ΔP received in S225. In various implementations, the ground device 300 may calculate and send the vision sensor based absolute location P_{VISION} to the UAV 100.

In S230, the UAV 100 lands on the landing point 10 using the vision sensor based absolute location P_{VISION}.

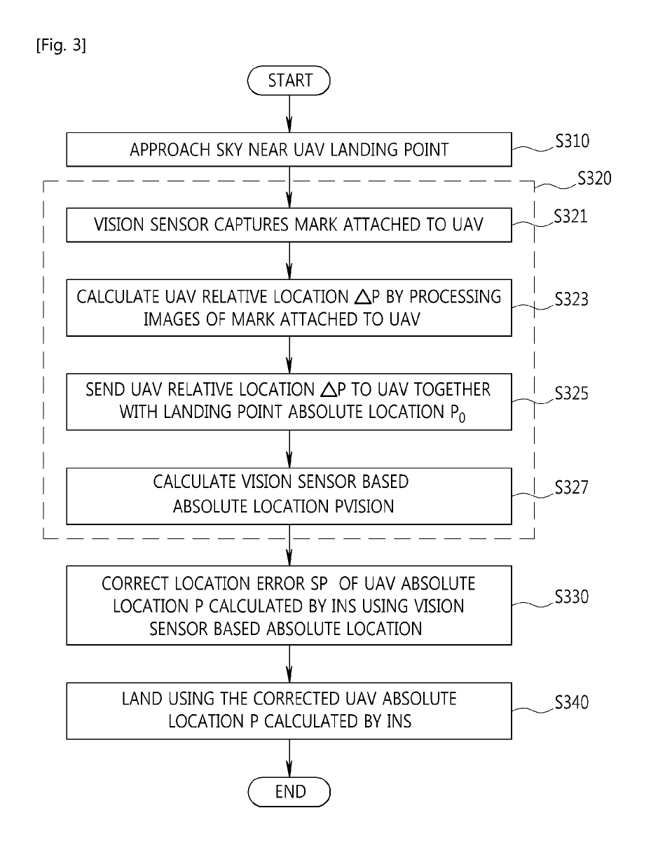

FIG. 3 is a flowchart of operations of the UAV landing system according to another exemplary embodiment of the present invention.

S310 and S320 are the same as S210 and S220 of FIG. 2.

Using a GPS location P_{GPS} measured by the GPS receiver of the UAV 100 and the vision sensor based absolute location P_{VISION} , the UAV 100 corrects a location error δₚ of the UAV absolute location P calculated by the INS of the UAV 100 in S330.

In S340, the UAV 100 lands on the landing point 10 using the UAV absolute location P calculated by the INS of the UAV 100 with the location error δₚ corrected.

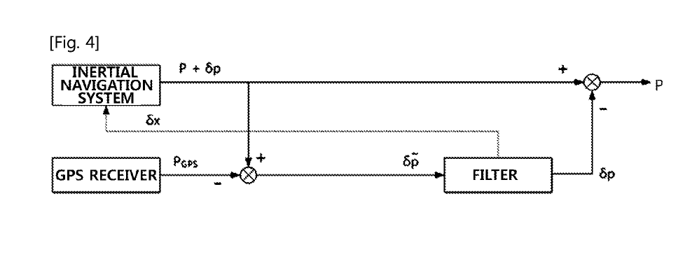

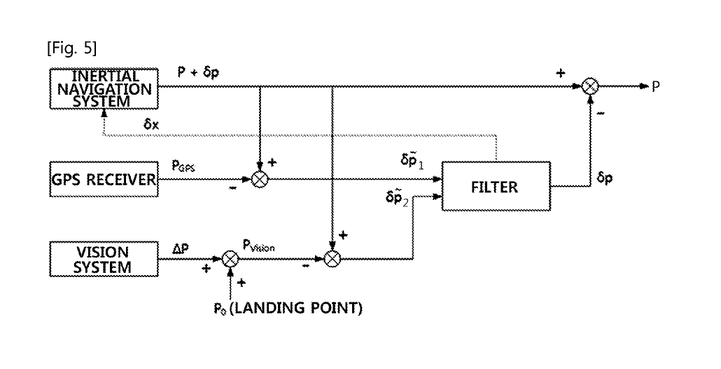

The correction of the location error δₚ of the UAV absolute location P calculated by the INS in S330 shall be explained by referring to FIGS. 4 and 5.

The INS, which calculates a location and a position of a flying object by integrating an acceleration and an angular velocity measured by an accelerometer and a gyroscope, accumulates the error as time passes. To address the error, a filter for estimating the error of the INS is used and the error of the INS is estimated using the location P_{GPS} measured by the GPS receiver as a filter measurement.

FIG. 4 depicts an algorithm for calculating the corrected location of the UAV by estimating the error of the conventional INS.

Referring to FIG. 4, when the UAV absolute location P+δₚ including the error δₚ calculated by the INS and a differential value δ_{\tilde{p}} of the UAV location P_{GPS} measured by the GPS receiver are input as the filter measurement, the filter estimates and outputs the measurement error δₚ of the INS. Next, the corrected UAV location P is output by excluding δₚ from the UAV absolute location P+δₚ calculated by the INS. While the filter can estimate and feed the location, the velocity, the position, and a sensor bias error δₓ of the INS back to the INS and output the corrected velocity and the position as well, the location P is shown alone in FIG. 4 to ease the understanding.

To correct the error of the conventional INS in FIG. 4, the present invention adds the vision sensor based absolute location P_{VISION} as the measurement which is input to the filter.

FIG. 5 depicts an algorithm for calculating the corrected UAV location by estimating the error of the INS.

Referring to FIG. 5, the algorithm calculates the UAV absolute location P+δₚ including the error calculated by the INS of the UAV. Next, the algorithm calculates a first differential value δ_{\tilde{p}1} corresponding to the difference between the UAV absolute location P+δₚ calculated by the INS, and the GPS location P_{GPS} measured by the GPS receiver of the UAV. The algorithm calculates a second differential value δ_{\tilde{p}2} corresponding to the difference between the UAV absolute location P+δₚ calculated by the INS and the vision sensor based absolute location P_{VISION} The algorithm calculates the UAV absolute location error δₚ calculated by the INS by Kalman-filtering the first differential value δ_{\tilde{p}1} and the second differential value δ_{\tilde{p}2}. Next, the algorithm corrects the location error δₚ at the INS based absolute location P+δₚ and thus obtains the corrected UAV absolute location P.

Now, the filter mentioned in FIGS. 4 and 5 is described in detail.

To estimate the error of the INS, the Kalman filter of GPS/INS loosely coupled integration is mostly used. The Kalman filtering of the loosely coupled integration includes two steps of time propagation and measurement update of a state equation. Equation 1 is a system model used for the time propagation of the Kalman filter to estimate the INS error. The system model has a fifteenth-order state variable by adding a bias error model of the gyroscope and the accelerometer to a ninth-order location, velocity, position error model.

$$δ \dot{x} ( t ) = F ( t ) {δ}_{x} ( t ) + G ( t ) w = [ \begin{matrix}{F}_{pp} & {F}_{pv} & 0 & 0 & 0 \\ {F}_{vp} & {F}_{vv} & {F}_{va} & {C}_{b}^{n} & 0 \\ {F}_{ap} & {F}_{av} & {F}_{aa} & 0 & {C}_{b}^{n} \\ 0 & 0 & 0 & {F}_{{b}_{a}} & 0 \\ 0 & 0 & 0 & 0 & {F}_{{b}_{g}}\end{matrix} ] [ \begin{matrix}δ p \\ δ v \\ δ a \\ {δ}_{{b}_{a}} \\ δ {b}_{g}\end{matrix} ] + [ \begin{matrix}0 & 0 \\ {C}_{b}^{n} & 0 \\ 0 & {C}_{b}^{n} \\ 0 & 0 \\ 0 & 0\end{matrix} ] w \\ w \sim ( 0 , Q ) \qquad [ Equation 1 ]$$

F(t) : a system of the INS error estimation Kalman filter

δₓ: a Kalman filter state variable, INS error (location, velocity, position, sensor bias error)

w: process noise, white noise having a zero mean and a variance Q

C_{b}ⁿ: a coordinate transformation matrix for converting a body coordinate system to a navigation coordinate system

The measurement update uses the location and the velocity measurement provided from the GPS receiver. Equation 2 expresses the measurement update in consideration of only the location measurement of the GPS receiver. A measurement noise ν_{GPS} is the white noise with the zero mean and the variance R_{GPS}, and is determined by reflecting noise characteristics of the location measurement of the GPS receiver.

z_{GPS}(t)=P_{GPS}−P_{INS}=Hδ×(t)+ν_{GPS}, H=[I_{3×3}0_{12×3}] ν_{GPS}˜(0, R_{GPS}) [Equation 2]

The Kalman filtering can enhance the filter performance (estimation accuracy, filter convergence rate, etc.) by using the measurements of the different sensors.

In FIG. 5, the system has the additional location measurement P_{VISION} by combining the absolute location of the landing point and the relative location of the flying object calculated by the vision system. This can be used to for the additional measurement update of the Kalman filter thus enhancing the filter performance. Even when the GPS receiver is unavailable because of GPS signal interference or jamming, the filter can operate normally. Equation 3 expresses the additional measurement update using P_{VISION}. The measurement noise νᵥᵢₛᵢₒₙ is the white noise with the zero mean and the variance R_{VISION}, and is determined by reflecting the noise characteristics of the location measurement of the vision system.

z_{Vision}(t)=P^{Vision}−P_{INS}=Hδ×(t)+ν_{Vision}, H=[I_{3×3}0_{12×3}] ν_{Vision}˜(0, R_{Vision}) [Equation 3]

While the UAV according to the present invention is applied to a vertical take-off and landing UAV, it is applicable to other aircrafts which take off and land in other various fashions.

As set forth above, in the method and the system for landing the UAV according to exemplary embodiments of the present invention, the plurality of the sensors installed near the landing point can calculate more precise location and position of the UAV using the relative location of the UAV and the absolute location of the landing point by recognizing the mark attached to the UAV, and thus land the UAV on the landing point accurately.

In a downtown area or an area where it is difficult to locate the UAV using the GPS due to the jamming or the interference, the accurate location of the UAV can be measured in place of the GPS.

As the UAV can make the stable landing, it is possible to reduce separate personnel for the manual landing of the conventional UAV and to address the burden caused by the limited vision of the external pilot.

Further, the efficiency can be enhanced based on the landing of the UAV, and cost can be reduced by replacing the conventional high-priced landing device.

Thus, reliability of the UAV landing system can be improved.

The embodiments of the present invention can include a computer-readable medium including a program command executed by various computers. The medium records a program for fulfilling the UAV landing method as described above. The medium can include a program command, a data file, a data structure, etc. alone or in combination. Examples of the medium include magnetic media such as a hard disk, a floppy disk, and a magnetic tape, optical media such as a CD-ROM and a DVD, magneto-optical media such as a floptical disk, and a hardware device configured to store and execute a program command, such as a ROM, a RAM, and a flash memory. The medium can be a transfer medium such as light, a metal wire or a waveguide including carrier waves for transmitting signals required to designate program instructions, and data structures. Examples of the program command include a premium language code executable by a computer using an interpreter as well as a machine language code generated by a compiler.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for landing an Unmanned Aerial Vehicle (UAV), comprising:
recognizing a mark installed to the UAV through a plurality of vision sensors installed around a landing point of the UAV; and
calculating a relative location of the UAV based on the landing point using the mark recognized by the vision sensors.

2. The method of claim 1, further comprising:
sending the relative location of the UAV and an absolute location of the landing point to the UAV.

3. The method of claim 1, further comprising:
calculating a vision sensor based absolute location of the UAV using the relative location of the UAV and an absolute location of the landing point.

4. The method of claim 3, further comprising:
correcting a location error of the absolute location of the UAV calculated by an Inertial Navigation System (INS) of the UAV using a Global Positioning System (GPS) location measured by a GPS receiver of the UAV and the vision sensor based absolute location.

5. The method of claim 4, wherein the correcting of the location error of the absolute location of the UAV calculated by the INS of the UAV comprises:
calculating an absolute location of the UAV calculated by the INS of the UAV;
calculating a first differential value corresponding to a difference between the absolute location of the UAV calculated by the INS and the GPS location measured by the GPS receiver of the UAV;
calculating a second differential value corresponding to a difference between the absolute location of the UAV calculated by the INS and the vision sensor based absolute location;
calculating the location error of the absolute location of the UAV measured by the INS by Kalman-filtering the first differential value and the second differential value; and
correcting the location error at the INS based absolute location and obtaining the corrected absolute location of the UAV.

6. A system for landing an UAV, comprising:
a plurality of vision sensors installed around a landing point of the UAV and recognizing a mark installed to the UAV; and
a ground device for calculating a relative location of the UAV based on the landing point using the mark recognized by the vision sensors.

7. The system of claim 6, wherein the ground device sends the relative location of the UAV and an absolute location of the landing point to the UAV.

8. The system of claim 6, wherein the UAV calculates a vision sensor based absolute location of the UAV using the relative location of the UAV and an absolute location of the landing point.

9. The system of claim 8, wherein the UVA corrects a location error of the absolute location of the UAV calculated by an INS of the UAV using a GPS location measured by a GPS receiver of the UAV and the vision sensor based absolute location.

10. The system of claim 9, wherein the UAV corrects the location error of the absolute location of the UAV calculated by the INS of the UAV, calculates an absolute location of the UAV calculated by the INS of the UAV, calculates a first differential value corresponding to a difference between the absolute location of the UAV calculated by the INS and the GPS location measured by the GPS receiver of the UAV, calculates a second differential value corresponding to a difference between the absolute location of the UAV calculated by the INS and the vision sensor based absolute location, calculates the location error of the absolute location of the UAV measured by the INS by Kalman-filtering the first differential value and the second differential value, corrects the location error at the INS based absolute location, and obtains the corrected absolute location of the UAV.

11. A computer-readable medium recording a program for executing the method of claim 1 in a computer.
